(19) United States
(12) Patent Application Publication
(10) Pub. No.: US 2024/0396104 A1
(43) Pub. Date: Nov. 28, 2024

(54) POWER STORAGE SYSTEM

(71) Applicant: Toyota Jidosha Kabushiki Kaisha, Toyota-shi (JP)

(72) Inventors: Jumpei HOSOI, Seto-shi (JP); Masashi KOBAYASHI, Toyota-shi (JP); Toru ANDO, Obu-shi (JP)

(73) Assignee: Toyota Jidosha Kabushiki Kaisha, Toyota-shi (JP)

(21) Appl. No.: 18/658,358

(22) Filed: May 8, 2024

(30) Foreign Application Priority Data
May 23, 2023 (JP) 2023-084615

(51) Int. Cl. H01M 10/44; B60L 1/08; B60L 58/12; B60L 58/27; H02J 7/00

(52) U.S. Cl. CPC H01M 10/443; B60L 1/08; B60L 58/12; B60L 58/27; H02J 7/0036; B60L 2240/545

(57) ABSTRACT

A power storage system includes: a power storage device mounted on a vehicle; a heat source configured to be capable of heating the power storage device with electric power; and a control device configured to control the heat source. The control device is configured to detect supply power that is supplied to the vehicle from a power-supplying facility provided outside the vehicle, determine a first target temperature by using the detected supply power, and control the heat source to cause a temperature of the power storage device to approach the first target temperature.

### CROSS REFERENCE TO RELATED APPLICATIONS

This nonprovisional application is based on Japanese Patent Application No. 2023-084615 filed on May 23, 2023 with the Japan Patent Office, the entire contents of which are hereby incorporated by reference.

### BACKGROUND

### Field

The present disclosure relates to a power storage system.

### Description of the Background Art

In WO2022/202308, in order to suppress the progress of deterioration of a secondary battery mounted on a vehicle, a technique is disclosed in which a heating target temperature is set using charge/discharge information on whether or not the secondary battery is charged and discharged, and the secondary battery is heated so that the temperature of the secondary battery approaches the set heating target temperature.

### SUMMARY

However, when the power storage device during charging is in a low temperature state, the charging power is limited due to a decrease in the acceptable current of the power storage device, and there may be a problem that the charging time of the power storage device (that is, the time taken until the charging of the power storage device is completed) becomes long. Therefore, in order to shorten the charging time of the power storage device, it is conceivable to heat the power storage device to a sufficiently high temperature by, for example, an electric heater during charging of the power storage device. However, when electric power is supplied to the vehicle from the outside of the vehicle, if the amount of electric power consumed for heating the power storage device in the vehicle increases, the amount of electric power charged in the power storage device decreases, and the charging time of the power storage device may increase. Therefore, it is required to appropriately set the target temperature of the power storage device. However, in WO2022/202308, there is no mention of setting the target temperature of the power storage device to an appropriate temperature in order to shorten the charging time of the power storage device.

The present disclosure has been made to solve the above problem, and an object thereof is to adjust a temperature of a power storage device during charging so that a charging time of the power storage device is shortened.

A power storage system according to the present disclosure includes: a power storage device mounted on a vehicle; a heat source configured to be capable of heating the power storage device with electric power; and a control device configured to control the heat source. The control device is configured to detect supply power that is supplied to the vehicle from a power-supplying facility provided outside the vehicle, determine a first target temperature by using the detected supply power, and control the heat source to cause a temperature of the power storage device to approach the first target temperature.

In the low temperature region, as the temperature of the power storage device increases, the acceptable power of the power storage device tends to increase. However, even if the acceptable power of the power storage device is large, if the power supplied to the power storage device is small, the charging power of the power storage device does not become large, and the charging time of the power storage device (time to completion of charging) does not become short. For example, when a power storage device mounted on a vehicle is charged by a power-supplying facility provided outside the vehicle, supply power that is supplied from the power-supplying facility to the vehicle may decrease due to the power-supplying facility. When the power storage device is heated in such a situation, not only the charging power of the power storage device is not increased, but also the charging time of the power storage device may be prolonged due to power consumption for heating the power storage device.

In this regard, in the power storage system, the target temperature (first target temperature) in the heating control of the power storage device is determined by using the supply power supplied from the power-supplying facility to the vehicle. This makes it possible to determine an appropriate target temperature (first target temperature) in accordance with the power supplied from the power-supplying facility to the vehicle. Therefore, according to the power storage system, the temperature of the power storage device during charging can be easily adjusted so that the charging time of the power storage device is shortened.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating a schematic configuration of a vehicle according to an embodiment of the present disclosure.

FIG. 2 is a diagram showing the configuration of the periphery of the power storage device shown in FIG. 1.

FIG. 3 is a flowchart illustrating processing related to heating control of the power storage device according to the embodiment of the present disclosure.

FIG. 4 is a diagram showing the transition of the temperature of the power storage device in the first operation example related to the control shown in FIG. 3.

FIG. 5 is a diagram showing the transition of the temperature of the power storage device in the second operation example related to the control shown in FIG. 3.

### DESCRIPTION OF THE PREFERRED EMBODIMENTS

Embodiments of the present disclosure will be described in detail with reference to the drawings. In the drawings, the same or corresponding parts are denoted by the same reference numerals, and the description thereof will not be repeated.

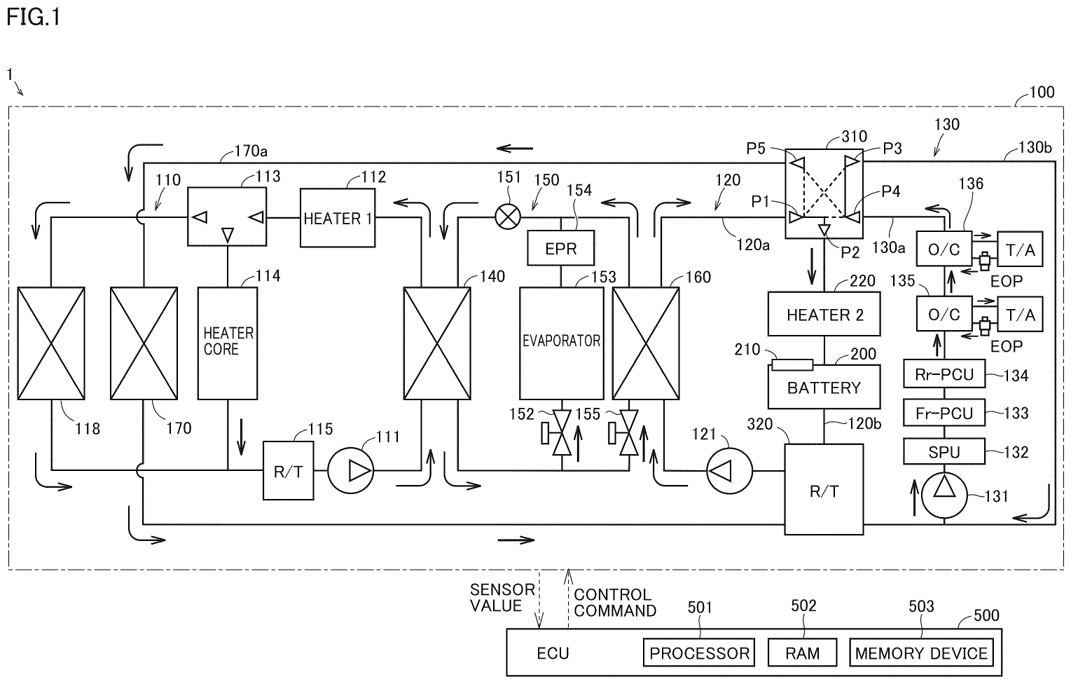

FIG. 1 is a diagram showing a schematic configuration of a vehicle according to this embodiment. As shown in FIG. 1, a vehicle 1 is an electrically powered vehicle (xEV) equipped with a power storage system according to this embodiment. The vehicle 1 is, for example, a four-wheel BEV (battery electric vehicle). However, the vehicle 1 may be another electrically powered vehicle such as a plug-in hybrid electric vehicle. The vehicle 1 may be configured to be capable of wireless charging. The number of wheels is also arbitrary, and may be three or five or more.

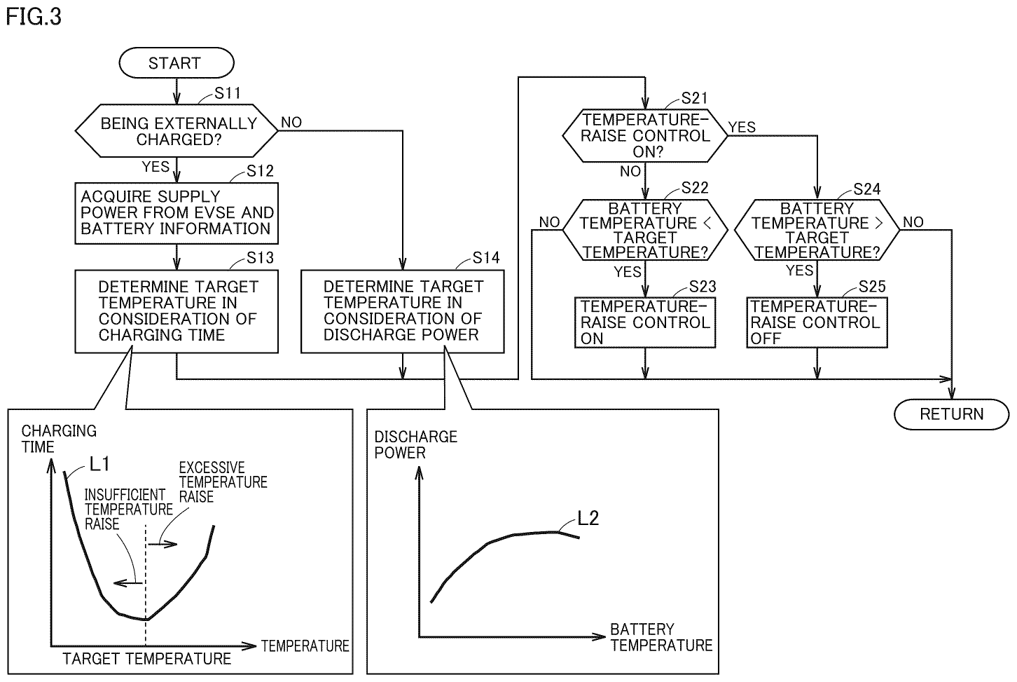

The vehicle 1 includes a thermal management circuit 100 and ECU (Electronic Control Unit) 500. The ECU 500 includes a processor 501, a random access memory (RAM) 502, and a memory device 503. As the processor 501, for example, a CPU (Central Processing Unit) can be adopted. The memory device 503 is configured to store written information. The memory device 503 stores information (map, mathematical expression, various parameters, and the like) used in the program in addition to the program. In this embodiment, the processor 501 executes a program stored in the memory device 503 to execute various controls (for example, refer to FIG. 3) in the ECU 500. However, various controls in the ECU 500 may be executed by hardware (electronic circuit) instead of software.

The thermal management circuit 100 is configured to perform thermal management of the vehicle 1 using a heat medium. The thermal management circuit 100 includes a first circuit 110, a second circuit 120, and a third circuit 130. The thermal management circuit 100 includes a capacitor 140, a refrigeration cycle 150, a chiller 160, a five-way valve 310, and a reservoir tank (R/T) 320. The five-way valve 310 and the reservoir tank 320 are shared by the second circuit 120 and the third circuit 130. The capacitor 140, the refrigeration cycle 150, and the chiller 160 are disposed between the first circuit 110 and the second circuit 120, and function as a heat transfer mechanism.

The first circuit 110 includes a first flow path through which the first heat medium flows. The first circuit 110 includes a pump 111, an electric heater 112 (first heater), a three-way valve 113, a heater core 114, a reservoir tank (R/T) 115, and a radiator 118. The three-way valve 113 switches the path of the first heat medium. The pump 111 circulates the first heat medium through the first circuit 110. Specifically, the pump 111 passes the first heat medium sucked from the reservoir tank 115 through the capacitor 140, the electric heater 112, and the heater core 114 or the radiator 118 connected by the three-way valve 113 in this order, and then returns the first heat medium to the reservoir tank 115. The first heat medium exchanges heat with each device when passing therethrough. The pump 111, the electric heater 112, and the three-way valve 113 are controlled by the ECU 500. The radiator 118 functions as a heat exchanger. The radiator 118 exchanges heat between the first heat medium flowing through the first circuit 110 and the outside air.

The five-way valve 310 switches the path of the second heat medium. The five-way valve 310 includes five ports P1 to P5. The ECU 500 controls the five-way valve 310 so as to have any of the first to fifth connection patterns described below. Hereinafter, the ports P1, P2, P3, P4, and P5 may be simply referred to as “P1”, “P2”, “P3”, “P4”, and “P5”, respectively.

In the first connection pattern, P1 and P2 are connected, P3 and P4 are connected, and P5 is disconnected. In the second connection pattern, P1 and P2 are connected, P4 and P5 are connected, and P3 is disconnected. In the third connection pattern, P1 and P5 are connected, P3 and P4 are connected, and P2 is disconnected. In the fourth connection pattern, P2 and P4 are connected, P1 and P3 are connected, and P5 is disconnected. In the fifth connection pattern, P2 and P4 are connected, P1 and P5 are connected, and P3 is disconnected.

Flow paths 120a and 120b are connected to ports P1 and P2 of the five-way valve 310, respectively. The flow path 120a is a flow path that connects the port P1 and the reservoir tank 320. The flow path 120b is a flow path connecting the port P2 and the reservoir tank 320. By connecting P1 and P2 of the five-way valve 310 (for example, the first and second connection patterns), the second circuit 120 including the flow paths 120a and 120b is formed.

A pump 121 and a chiller 160 described later are disposed in the flow path 120a. The battery 200 and the electric heater 220 (second heater) are disposed in the flow path 120b. The pump 121 circulates the second heat medium through the second circuit 120. Specifically, the pump 121 passes the second heat medium sucked from the reservoir tank 320 through the chiller 160, the five-way valve 310, the electric heater 220, and the battery 200 in this order, and then returns the second heat medium to the reservoir tank 320. The second heat medium exchanges heat with each device when passing therethrough. The second heat medium that exchanges heat with the battery 200 flows through the flow path 120b. The pump 121 and the electric heater 220 are controlled by the ECU 500. The battery 200 is provided with BMS (Battery Management System) 210 for monitoring the state of the battery 200.

Flow paths 130b and 130a are connected to ports P3 and P4 of the five-way valve 310, respectively. The flow paths 130b and 130a are flow paths that connect the ports P3 and P4 to the reservoir tank 320, respectively. When P3 and P4 of the five-way valve 310 are connected (for example, the first and third connection patterns), the third circuit 130 including the flow paths 130a and 130b is formed.

In this embodiment, a heat medium (second heat medium) of the same type as the heat medium circulating through the second circuit 120 circulates through the third circuit 130. The first heat medium circulating through the first circuit 110 is a heat medium of a type different from that of the second heat medium. The third heat medium used in the refrigeration cycle 150 described later is also a heat medium of a type different from the first and second heat media. For example, the first heat medium may be a known heat medium for heating. The second heat medium may be an insulating oil or an antifreeze. The third heat medium may be a known heat medium for a refrigeration cycle. Without being limited as such, each of the first to third heat media can be appropriately changed.

A pump 131, a SPU (Smart Power Unit) 132, PCU (Power Control Unit) 133,134, and oil coolers (O/C) 135 and 136 are disposed in the flow path 130a. The pump 131 circulates the second heat medium through the third circuit 130.

Specifically, the pump 131 passes the second heat medium sucked from the reservoir tank 320 through the SPU 132, the PCUs 133 and 134, the oil coolers 135 and 136, and the five-way valve 310 in this order, and then returns the second heat medium to the reservoir tank 320. The second heat medium exchanges heat with each device when passing therethrough. Each of the oil coolers 135 and 136 cools oil supplied to the T/A of the vehicle 1 by an electric oil pump (EOP). The second heat medium flowing through the oil coolers 135 and 136 exchanges heat with the oil for the T/A. One or more temperature sensors that detect the temperature of the second heat medium flowing through the flow path 130a may be provided in a predetermined portion (for example, in the vicinity of each PCU).

A flow path 170a is connected to the port P5 of the five-way valve 310. The flow path 170a is a flow path connecting the port P5 and the reservoir tank 320. A radiator 170 is provided in the flow path 170a. The radiator 170 functions as a heat exchanger. The radiator 170 exchanges heat between the heat medium flowing through the flow path 170a and the outside air. The ECU 500 can cool the second heat medium by heat exchange in the radiator 170 by connecting the flow path 120a or 130a to the flow path 170a by the five-way valve 310.

The third heat medium circulates in the refrigeration cycle 150. The refrigeration cycle 150 includes a compressor 151, an electric expansion valve 152, an evaporator 153, an evaporation pressure regulating valve (EPR: Evaporative Pressure Regulator) 154, and an electric expansion valve 155. The capacitor 140 is connected to both the first circuit 110 and the refrigeration cycle 150 and functions as a heat exchanger. The capacitor 140 exchanges heat between the first heat medium flowing through the first circuit 110 and the third heat medium circulating through the refrigeration cycle 150. The chiller 160 is connected to both the refrigeration cycle 150 and the flow path 120a and functions as a heat exchanger. When the five-way valve 310 is in the first or second connection pattern, the chiller 160 exchanges heat between the third heat medium circulating through the refrigeration cycle 150 and the second heat medium flowing through the second circuit 120. The refrigeration cycle 150 (including the compressor 151 and various valves) is controlled by the ECU 500. One or more pressure sensors and one or more temperature sensors that respectively detect the pressure and temperature of the third heat medium flowing through the refrigeration cycle 150 may be provided at predetermined positions.

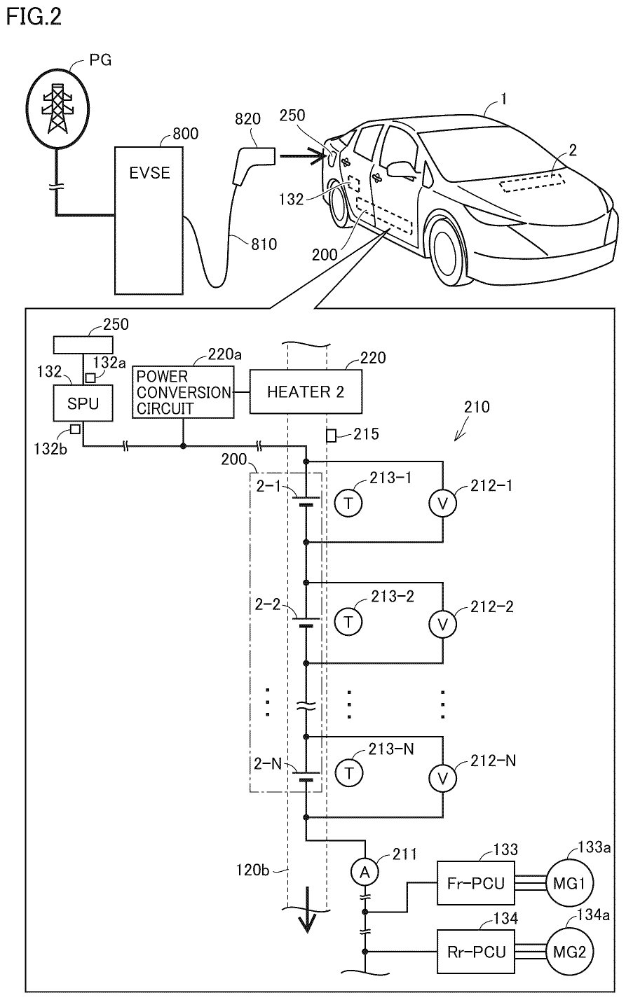

FIG. 2 is a diagram illustrating a configuration of the battery 200 and the BMS 210. Referring to FIG. 2, battery 200 is a battery assembly configured by connecting N cells 2-1 to 2-N. N is a natural number of 2 or more, and may be 2 or more and less than 100, or 100 or more. The cells 2-1 to 2-N are connected in series. However, the connection mode of the cells in the battery assembly is not limited to series connection, and may include parallel connection.

The air conditioning device 2 mounted on the vehicle 1 performs air conditioning (heating and cooling) of the inside of the vehicle 1 using the first circuit 110 and the refrigeration cycle 150. The electric heater 112 heats the first heat medium in the first circuit 110 in accordance with a command from the ECU 500.

The heater core 114 warms the air in the vehicle interior by heat exchange with the first heat medium. The evaporator 153 of the refrigeration cycle 150 cools the air in the vehicle interior.

The vehicle 1 includes one or more MGs (motor generators), and is configured to be capable of traveling by electric power discharged from the battery 200. In this embodiment, the vehicle 1 includes an MG 133a (front motor) and an MG 134a (rear motor). The PCUs 133 and 134 drive the MGs 133a and 134a, respectively, using power supplied from the battery 200. The torque output from each MG rotates the drive wheels of the vehicle 1 via a transaxle (T/A). The T/A functions as a power transmission mechanism. The battery 200 functions as a power storage device for traveling. Each PCU may include a bi-directional inverter. The SPU 132 and each PCU are controlled by the ECU 500.

The battery 200 supplies electric power to various devices included in the thermal management circuit 100 illustrated in FIG. 1. The battery 200 supplies power to the electric heater 220 via a power conversion circuit 220a (for example, a DC/DC converter). The electric heater 220 is located in the vicinity of the battery 200. The electric heater 220 is driven by electric power supplied from the battery 200, and heats the second heat medium flowing through the flow path 120b. At least one of the various devices included in the thermal management circuit 100 may be supplied with electric power from an in-vehicle battery (for example, an auxiliary battery (not shown)) other than the battery 200.

The BMS 210 includes a current sensor 211 that detects a current flowing through the battery 200 (battery assembly), voltage sensors 212-1 to 212-N and temperature sensors 213-1 to 213-N corresponding to the cells 2-1 to 2-N, respectively, and a temperature sensor 215 that detects the ambient temperature of the battery 200. The temperature sensor 215 detects the temperature of the second heat medium flowing through the flow path 120b in the vicinity of the battery 200. The detection results of the respective sensors are input to the ECU 500.

The ECU 500 can acquire the current of the battery 200, the ambient temperature of the battery 200, and the voltage and the temperature of each cell of the battery 200 based on the signals from the sensors. The ECU 500 can calculate a state of charge (SOC) for each cell from the detection results of the sensors. The SOC represents a ratio of a current amount of charge to an amount of charge in a fully charged state, for example, in a range of 0 to 100%. The configuration of the BMS 210 can be appropriately changed.

The vehicle 1 includes an inlet 250. The inlet 250 functions as a charging port. EVSE (Electric Vehicle Supply Equipment) 800 includes a charging cable 810 extending outwardly from the body of the EVSE 800. Inlet 250 is configured such that connector 820 (distal end portion) of charging cable 810 is detachable. When the connector 820 of the charging cable 810 connected to the main body of the EVSE 800 is connected to the inlet 250 of the vehicle 1 in the parked state, the vehicle 1 is in a state of being electrically connected to the EVSE 800 (plug-in state). The EVSE 800 and the power grid PG are electrically connected to each other. Therefore, the vehicle 1 in the plug-in state is electrically connected to the power grid PG. The power grid PG is an electric power network constructed by electric power transmission and distribution facilities. A plurality of power plants are connected to the power grid PG.

The SPU 132 functions as an in-vehicle charger/discharger (a charger and a discharger) of the battery 200. However, it is not essential that the vehicle 1 have an external power feed function (for example, a V2H function). The SPU 132 includes, for example, a power conversion circuit. Sensors 132a and 132b for detecting input power and output power of the SPU 132 are provided on an input side and an output side of the SPU 132, respectively. Each of the sensors 132a, 132b includes a current sensor and a voltage sensor.

When the vehicle 1 in the plug-in state performs external charging (charging of the battery 200 by electric power from the outside of the vehicle), electric power supplied from the power grid PG is input to the inlet 250 via the EVSE 800. The sensor 132a detects supply power supplied from the EVSE 800 to the vehicle 1. The SPU 132 generates charging power according to an instruction from the ECU 500 using the power input to the inlet 250, and inputs the generated charging power to the battery 200. For example, the EVSE 800 supplies AC power to the inlet 250. The SPU 132 may perform AC/DC conversion and voltage transformation to generate charging power. However, the power supply method of the EVSE 800 is not limited to the AC method, and may be a DC method.

FIG. 3 is a flowchart illustrating processing related to heating control of the battery 200 performed by the ECU 500. Each step in the flowchart is denoted by “S”. The process shown in this flowchart is repeatedly executed during the use period of the battery 200. The period of use of the battery 200 may be a period of time during which the control system of the battery 200 is operating. The ECU 500 may determine that the use period of the battery 200 has started when the activation switch of the vehicle 1 is turned on by the user. The ECU 500 may determine that the use period of the battery 200 has ended when the user turns off the activation switch of the vehicle 1. In general, the activation switch is referred to as a “power switch”, an “ignition switch”, or the like.

Referring to FIG. 3, in S11, ECU 500 determines whether or not battery 200 is being externally charged. ECU 500 may determine that external charging of battery 200 has started when a charging start signal is received from a power-supplying facility (e.g., EVSE 800) connected to vehicle 1. The ECU 500 reserved for timer charging may determine that external charging of the battery 200 has started when the start time of timer charging arrives. The ECU 500 may determine whether or not the external charging of the battery 200 is ended based on whether or not the charging end condition is satisfied during the external charging of the battery 200. The charging end condition is satisfied, for example, when the SOC of the battery 200 reaches a target value (target SOC value). The target value may be automatically set by the ECU 500 or may be set by the user. The target value may be 100% (SOC value indicating full charge). The fact that the SOC of the battery 200 reaches the target value means that the charging of the battery 200 is completed. The fact that the charging termination condition is satisfied before the SOC of the battery 200 reaches the target value means that the charging of the battery 200 is terminated before the charging of the battery 200 is completed. The charging end condition is also satisfied when the charging cable is removed from the inlet 250. Further, the charging end condition may be satisfied when a predetermined time has elapsed from the start of the external charging. The charging termination condition may be satisfied in response to a charging stop instruction from the user. Note that the charging termination condition can be appropriately changed.

When the battery 200 is performing external charging (YES in S11), the ECU 500 acquires, in S12, the supply power supplied to the vehicle 1 from the power-supplying facility connected to the vehicle 1 and the battery information indicating the current state of the battery 200. In this embodiment, the supply power is detected by a sensor 132a (FIG. 2). However, the present disclosure is not limited thereto, and the ECU 500 may receive information indicating the supply power from the power-supplying facility. The battery information includes the ambient temperature (the temperature of the second heat medium) of the battery 200, the temperature of each cell, and the SOC detected by the BMS 210.

In S13, the ECU 500 determines the target temperature in the heating control of the battery 200 using the information acquired in S12. Specifically, the ECU 500 specifies the battery temperature at which the remaining time to complete the charging of the battery 200 (hereinafter, referred to as “remaining charging time”) is minimized, based on the supply power from the power-supplying facility, the ambient temperature of the battery 200, the SOC of the battery 200, and the target SOC value (SOC value at the time of completion of charging), and determines the specified battery temperature as the target temperature. In a low temperature region (e.g., a region of less than 0° C.), the higher the temperature of the battery 200, the greater the acceptable power of the battery 200.

Specifically, as indicated by a graph L1 in FIG. 3, the remaining charging time becomes long even when the battery temperature is too high or too low. The longer remaining charging time means that the charge completion time of the battery 200 becomes later. In a state where the temperature of the battery 200 is sufficiently high, the acceptable power of the battery 200 may not increase even when the battery 200 is heated. In addition, when the power supplied to the battery 200 is small, the charging time of the battery 200 is not shortened even if the acceptable power of the battery 200 becomes large. Therefore, the ECU 500 specifies the target temperature at which the remaining charging time becomes the shortest using the information acquired in S12. This facilitates shortening the charging time of the ECU 500.

The ECU 500 may acquire the battery temperature at which the remaining charging time becomes the shortest by using a prediction program optimized for the battery 200 or a learned model generated by machine learning of artificial intelligence (AI). The memory device 503 may store the prediction program or the learned model. The learned model may be learned to output the battery temperature at which the remaining charging time becomes the shortest when the supply power from the power-supplying facility, the ambient temperature of the battery 200, the SOC of the battery 200, and the target SOC value are input. Big data stored in the cloud may be used to learn the model. Note that the maximum cell temperature, the minimum cell temperature, or the average cell temperature of the battery 200 may be employed instead of the ambient temperature of the battery 200. The SOC of the battery 200 corresponds to the amount of charge in the battery 200. The target temperature determined in S13 corresponds to an example of the “first target temperature” according to the present disclosure.

When the process of S13 is executed, the process proceeds to S21. In S21, the ECU 500 determines whether or not the temperature-raise control of the battery 200 is being executed. The temperature-raise control of the battery 200 is control for raising the temperature of the battery 200. The ECU 500 raises the temperature of the battery 200 by heat generated by the electric heater 220, for example. When the amount of heat for raising the temperature of the battery 200 is insufficient by the heat generated only by the electric heater 220, the ECU 500 may activate the electric heater 112 in addition to the electric heater 220. In this embodiment, the ECU 500 controls the electric heaters 112 and 220 to drive the pumps 111, 121, and 131 in a state in which the five-way valve 310 is in the first connection pattern and to raise the temperature of the battery 200, thereby executing the temperature-raise control. The heat generated by the electric heater 112 is transmitted to the battery 200 via the first heat medium, the capacitor 140, the third heat medium (the refrigeration cycle 150), the chiller 160, and the second heat medium. The heat generated by the electric heater 220 is transmitted to the battery 200 through the second heat medium. When the temperature-raise control is not executed, the ECU 500 stops both of the electric heaters 112 and 220. The ECU 500 may set the five-way valve 310 to the third connection pattern when the temperature-raise control is not executed. Note that the temperature-raise control illustrated here is merely an example, and the mode of the temperature-raise control can be appropriately changed. Hereinafter, a state in which the temperature-raise control is executed is referred to as “temperature-raise control ON”, and a state in which the temperature-raise control is not executed is referred to as “temperature-raise control OFF”.

When determination as “temperature-raise control OFF” is made in S21 (NO in S21), ECU 500 determines whether or not the battery temperature (the temperature of battery 200) is lower than the target temperature in S22. In this embodiment, the lowest cell temperature (that is, the lowest cell temperature among the temperatures of the cells included in the battery 200) is employed as the “battery temperature” in each of S22 and S24 described later. During external charging of the battery 200, the target temperature (first target temperature) determined in S13 is employed as the “target temperature” in each of S22 and S24 described later.

When the temperature of battery 200 is lower than the target temperature (YES in S22), ECU 500 switches from temperature-raise control OFF to temperature-raise control ON in S23. As a result, temperature-raise control of the battery 200 by the ECU 500 is started. Thereafter, the process returns to the first step (S11). On the other hand, when the temperature of battery 200 is equal to or higher than the target temperature (NO in S22), the process returns to S11 while keeping the temperature-raise control OFF.

When determination as “temperature-raise control ON” is made in S21 (YES in S21), ECU 500 determines whether or not the temperature of battery 200 is higher than the target temperature in S24. When the temperature of battery 200 is higher than the target temperature (YES in S24), ECU 500 switches from temperature-raise control ON to temperature-raise control OFF in S25. As a result, the temperature-raise control of the battery 200 is not executed. Thereafter, the process returns to S11. On the other hand, when the temperature of the battery 200 is equal to or lower than the target temperature (NO in S24), the process returns to S11 while keeping the temperature-raise control ON.

As described above, during external charging of the battery 200, the ECU 500 detects the supply power (S12), determines the first target temperature by using the detected supply power (S13), and controls the electric heaters 112 and 220 (heat sources) to cause the temperature of the battery 200 to approach the first target temperature (S21 to S25). The ECU 500 switches the electric heater 220 to operate or stop, based on the temperature of the battery 200 (S21 to S25).

When the battery 200 is not performing external charging (NO in S11), the process proceeds to S14. For example, when the vehicle 1 is traveling, NO is determined in S11. In S14, the ECU 500 determines the target temperature in the heating control of the battery 200, such that the discharge power of the battery 200 is a predetermined value or more. The predetermined value may be a fixed value or may be variable according to the situation of the vehicle 1. The predetermined value may be electric power required for traveling of the vehicle 1. The ECU 500 may determine the target temperature using a map indicating a relationship between the discharge power and the battery temperature with respect to the battery 200. For example, a map (a map indicating the temperature characteristics of the battery 200) as shown by the graph L2 in FIG. 3 may be stored in the memory device 503 in advance. The target temperature determined in S14 corresponds to an example of the “second target temperature” according to the present disclosure.

When the process of S14 is executed, the process proceeds to S21. Since the processes of S21 to S25 are already described, the description thereof will not be repeated. However, in a period during which external charging is not being performed (including a period during which the vehicle 1 is traveling), the target temperature (second target temperature) determined in S14 is employed as the “target temperature” in each of S22 and S24.

As described above, in a period during which external charging is not being performed (including a period during which the vehicle 1 is traveling), the ECU 500 determines the second target temperature so that the discharge power of the battery 200 is a predetermined value or more (S14), and controls the electric heaters 112 and 220 (heat sources) to cause the temperature of the battery 200 to approach the second target temperature (S21 to S25). In this embodiment, the target temperature (second target temperature) of the heating control of the battery 200 in a period during which the vehicle 1 is traveling is determined in a manner different from that during the external charging of the battery 200. Then, the temperature of the battery 200 is adjusted so that the battery 200 can discharge electric power sufficient for traveling of the vehicle 1. This makes it easier for the battery 200 to discharge electric power for traveling of the vehicle 1.

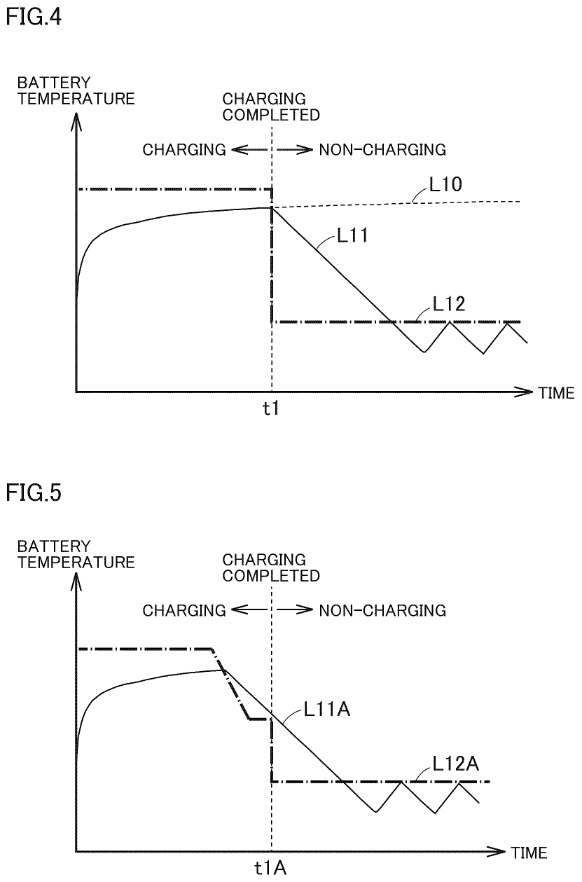

FIG. 4 is a diagram illustrating the transition of the temperature of the battery 200 in the first operation example related to the control illustrated in FIG. 3. In FIG. 4, a line L11 indicates the battery temperature, and a line L12 indicates the target temperature.

Referring to FIG. 4, when external charging of battery 200 ends at time t1, a determination of NO is made in S11 of FIG. 3. Thus, the target temperature (line L12) in the heating control of the battery 200 is switched from the first target temperature to the second target temperature. In the example shown in FIG. 4, the second target temperature is lower than the first target temperature. Therefore, when the external charging of the battery 200 ends, the temperature-raise control is stopped, and the temperature of the battery 200 (line L11) decreases. As a result, energy consumption in the vehicle 1 is suppressed. A broken line L10 in FIG. 4 indicates a transition of the battery temperature when the switching of the target temperature is not performed at the end of the external charging of the battery 200 (when the target temperature in the heating control is maintained at the first target temperature).

In the example shown in FIG. 4, the target temperature (first target temperature) in the heating control of the battery 200 is substantially constant during the external charging of the battery 200. However, the first target temperature may change according to a change in the supply power from the power-supplying facility or a change in the SOC (amount of charge) of the battery 200.

FIG. 5 is a diagram illustrating the transition of the temperature of the battery 200 in the second operation example related to the control illustrated in FIG. 3. In FIG. 5, a line L11A indicates the battery temperature, and a line L12A indicates the target temperature. In the example illustrated in FIG. 5, the ECU 500 lowers the first target temperature before the time t1A at which the external charging of the battery 200 ends (for example, a time after a predetermined time from the predicted charging completion time), thereby suppressing power consumption for heating the battery 200. In a state in which the amount of charge in the battery 200 is close to full charge, the effect of shortening the charging time may be greater in reducing the amount of power consumption by stopping the heating of the battery 200 than in increasing the acceptable power of the battery 200 by continuing the heating of the battery 200. The ECU 500 may decrease the first target temperature in accordance with a decrease in the supply power from the power-supplying facility.

As described above, the thermal management method according to this embodiment includes the processes shown in FIG. 3. The power storage system according to this embodiment includes: a power storage device (battery 200) mounted on a vehicle 1; a heat source (electric heater 220) configured to be capable of heating the power storage device with electric power; and a control device (ECU 500) configured to control the heat source. The ECU 500 is configured to detect supply power that is supplied to the vehicle 1 from a power-supplying facility (EVSE 800) provided outside the vehicle 1 (S12), determine a first target temperature by using the detected supply power (S13), and control the heat source (electric heater 220) to cause the temperature of the battery 200 to approach the first target temperature (S21 to S25). According to such a configuration, it is possible to determine an appropriate first target temperature in accordance with the supply power supplied from the power-supplying facility to the vehicle 1. Therefore, it is easy to adjust the temperature of the battery 200 during charging so as to shorten the charging time of the battery 200. The process flow illustrated in FIG. 3 can be appropriately changed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage system comprising:
a power storage device mounted on a vehicle;
a heat source configured to be capable of heating the power storage device with electric power; and
a control device configured to control the heat source,
the control device being configured to
detect supply power that is supplied to the vehicle from a power-supplying facility provided outside the vehicle,
determine a first target temperature by using the detected supply power, and
control the heat source to cause a temperature of the power storage device to approach the first target temperature.

2. The power storage system according to claim 1, wherein the control device is configured to determine the first target temperature by using the supply power, the temperature of the power storage device, and an amount of charge of the power storage device, while the power storage device is charged with the supply power.

3. The power storage system according to claim 2, wherein the control device is configured to determine the first target temperature such that a remaining time to complete charging of the power storage device is minimized.

4. The power storage system according to claim 1, wherein
the vehicle is configured to be capable traveling with electric power discharged from the power storage device, and
while the vehicle is traveling, the control device is configured to
determine a second target temperature such that discharge power of the power storage device is a predetermined value or more, and
control the heat source to cause the temperature of the power storage device to approach the second target temperature.

5. The power storage system according to claim 1, wherein
the heat source includes an electric heater configured to be driven by electric power supplied from the power storage device, and
the control device is configured to switch the electric heater to operate or stop, based on the temperature of the power storage device.
